(19) United States
(12) Patent Application Publication
(10) Pub. No.: US 2023/0167208 A1
(43) Pub. Date: Jun. 1, 2023

(54) HETEROGENEOUS CATALYST FOR HIGHLY-REACTIVE POLYISOBUTYLENE

(71) Applicant: Braskem S.A., Camacari (BR)

(72) Inventors: Jiahan Xie, Philadelphia, PA (US); Márcia Silva Lacerda Miranda, São Paulo City (BR); Cassandra Gallaschun, Philadelphia, PA (US); Marcio Andrade, São Paulo City (BR); Danniel Panza, São Paulo City (BR); Marcio Reboucas, São Paulo City (BR); Richard Caulkins, São Paulo City (BR); Alicia Brasselle, São Paulo City (BR); Jan Kalfus, Philadelphia, PA (US)

(73) Assignee: Braskem S.A., Camaçari (BR)

(21) Appl. No.: 18/070,124

(22) Filed: Nov. 28, 2022

Related U.S. Application Data
(60) Provisional application No. 63/284,395, filed on Nov. 30, 2021.

(51) Int. Cl. C08F 110/10

(52) U.S. Cl. CPC C08F 110/10

(57) ABSTRACT

A heterogeneous catalyst composition for preparing a highly-reactive polyisobutylene from isobutylene may include a Lewis acid, a support, an initiator, and optionally an electron donor. A method of polymerizing isobutylene to a highly-reactive polyisobutylene may include a heterogeneous catalyst composition including include a Lewis acid, a support, an initiator, and optionally an electron donor.

### BACKGROUND

Highly-reactive polyisobutylene refers to a polyisobutylene that holds greater than 50 mol % and preferentially greater than 80% of its double bonds (α-olefin) situated in a terminal position of the molecule, i.e., as a vinylidene group, as shown in the schematic below, where R is a polyisobutylene radical.

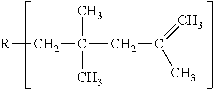

Polyisobutylenes are generally produced by cationic polymerization processes. Specifically, cationic polymerization is initiated by a proton donor species, by introducing a protonic acid (Bronsted acid) or an aprotic acid (Lewis acid). These species are known as catalysts or co-initiators. Protonic acids are species capable of donating protons, such as H⁺ ions, capable of interacting with the double bond present in the monomer and promoting the initiation of polymerization through the formation of the living polymeric chain. Cationic polymerization initiated through the use of Lewis acid occurs in the presence of a co-catalyst, also known as an initiator, such as: water, alcohol, organic acids or t-butyl chloride. The co-catalyst donates negatively-charged species to the catalyst so that it is possible to form the catalytic complex capable of initiating the polymerization of isobutylene with the proton-counterion pair.

To selectively produce highly-reactive polyisobutylene with high vinylidene content, precise tuning of basicity and steric structure of the counterion is commonly required. It has been demonstrated previously that adding an electron donor to Lewis acid and initiator (for example, adding alcohol or ether to BF₃ and water) can improve vinylidene content in PIB (U.S. Pat. Nos. 7,932,332, 9,683,060, 6,753,389). A mechanistic study has found that the electron donor may abstract the proton more efficiently during the propagation, thus avoid the unfavored isomerization of growing chain (Macromol. Symp. 2015, 349, 94-103). The additional steric hinderance in counterion may also favor the selective termination, which produces the highly-reactive polyisobutylene.

There are a variety of catalysts and processes described in the art for the production of highly-reactive polyisobutylene, which include both heterogeneous and homogeneous catalysts. Some examples of heterogeneous catalysts used in the polymerization of isobutylene are supported weakly coordinating anion/solvent mixtures, supported organic phosphoric acid, supported metal oxides, supported heteropolyacids, and supported boron fluoride/alcohol complexes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a heterogeneous catalyst composition for preparing a highly-reactive polyisobutylene that includes a Lewis acid, a support, an initiator, and optionally an electron donor.

In another aspect, embodiments disclosed herein relate to a method for polymerizing isobutylene to a highly-reactive polyisobutylene in the presence of a heterogeneous catalyst composition that includes a Lewis acid, a support, an initiator, and optionally an electron donor.

Other aspects and advantages of the claimed subject matter will be apparent from the following description and the appended claims.

### DETAILED DESCRIPTION

Embodiments of the present disclosure generally relate to a heterogeneous catalyst composition for producing highly-reactive polyisobutylene with a content of vinylidene per polyisobutylene chain of at least 50 mol %. Embodiments also relate to a process for polymerizing isobutylene in presence of such heterogeneous catalyst composition. As described, the heterogeneous catalyst composition of the present disclosure may include a Lewis acid, a support, an electron donor, and an initiator.

As used herein a “heterogeneous catalyst” refers to a catalyst that is in a different phase as the reactants (gas or liquid phase), whereas a “homogeneous catalyst” refers to a catalyst that is in the same phase as the reactants, generally in solution.

Lewis Acid

In one or more embodiments, the heterogeneous catalyst composition in accordance with the present disclosure includes a Lewis acid. In some embodiments, the Lewis acid may be a metal halide or alkyl metal halide. Metal halides may have a general formula of MⁿX⁻¹ₙ, where M is a metal, such as Al, B, Fe or Ti, X is a halide, such as F, Cl, or Br, and n is the number of valence electrons and may be 3 or 4. Alkyl metal halides may have a general formula R⁺¹Mⁿ⁺X⁻¹ₙ₋ₘ, where R is an alkyl group with the general formula CᵢH₂ᵢ₊₁, i is the number of carbon atoms and may be in the range from 2 to 10, m ranges from 1 to n−1, n is the number of valence electrons and may be 3 or 4, M is a metal, such as B, Al or Ti, and X is a halide, such as F, Cl, or Br.

Support

In one or more embodiments, the heterogeneous catalyst composition in accordance with the present disclosure includes a support on which the Lewis acid is loaded. As discussed above, precise control of basicity and steric size of counterion is required to obtain highly-reactive polyisobutylene. Thus, in accordance with present embodiments of the disclosure, the inorganic support is introduced to interact with Lewis acid and initiator to enlarge the steric size and to increase the base strength of counterion. Accordingly, the carbocation in the terminal vinyl position may be further stabilized to avoid the unfavored isomerization. Additionally, during the termination step, the stronger steric hinderance may selectively produce vinylidene-content polyisobutylene. These “steric effect” and “electronic effect) may thereby favor the production of highly reactive polyisobutylene. The support may be a metal oxide support, such as for example, silica, silica-alumina, clay, crystalline porous silicates, silicoaluminophosphates, titania, vanadia, and rare earth oxides, such as for example ceric oxide. In one or more embodiments, the support may be metal oxides with functionalized groups, such as hydroxyl, carboxylic, amino or thiol groups.

The heterogeneous catalyst composition in accordance with one or more embodiments of the present disclosure may include a weight percent of Lewis acid on the support that ranges from a lower limit of any of 1 wt %, 5 wt %, 10 wt %, or 15 wt % to an upper limit of any of 20 wt %, 25 wt %, or 30 wt %.

Initiator

In one or more embodiments, the heterogeneous catalyst composition in accordance with the present disclosure includes an initiator. An “initiator” is defined as a compound that can initiate polymerization, in the presence or absence of adventitious water and in the presence of a proton trap. The inclusion of an initiator may provide for activation of the catalyst and stabilization of the carbocation. The initiator, or co-catalyst, donates electrons to the catalyst so that it is possible to form the catalytic complex capable of initiating the polymerization of isobutylene. The main co-catalysts added to the catalytic system to promote the production of HR-PIB are dialkyl ether and water. The initiator may be water, alcohols, organic acids, alkyl chlorides or inorganic acids. The alcohol in one or more embodiments may be ethanol, n-propanol, i-propanol, n-butanol, 2-butanol, or t-butanol. The organic acid in one or more embodiments may be acetic acid, propanoic acid, or butanoic acid. The inorganic acid in one or more embodiments may be HCl, H₂SO₄, or H₃PO₄. The alkyl chloride in one or more embodiments may be C₂H₅Cl, n-C₃H₇Cl, i-C₃H₇Cl, n-C₄H₉Cl, 2-C₄H₉Cl, or t-C₄H₉Cl.

The heterogeneous catalyst composition in accordance with one or more embodiments of the present disclosure may include the molar ratio of initiator to Lewis acid ranging from a lower limit of any of 1:10, 1:8, 1:6, 1:4, or 1:2 to an upper limit of any of 1:1, 1.2:1, 1.4:1, 1.6:1, 1.8:1, or 2:1, where any lower limit can be used in combination with any upper limit. For example, in particular embodiments, the heterogeneous catalyst composition may include a molar ratio of water to aluminum in a range of about 1.5:1 to 1:1.5, such as, for example, 1:1.

Electron Donor

In one or more embodiments, the heterogeneous catalyst composition in accordance with the present disclosure may optionally include an electron donor. The introduction of external electron donors may further enhance the “steric effect” and “electronic effect” discussed previously and thus may further promote the vinylidene content and favor the production of highly-reactive polyisobutylene.

The electron donor may be a compound selected from an alcohol with 1 to 5 carbon atoms, a ketone with 3 to 6 carbon atoms, an ether, an aminated compound, a phosphate compound, a phenol, a pyridine and combinations thereof. In particular embodiments of the electron donor, the ether may be an alkyl ether. In yet other embodiment of the electron donor, the aminated compound may be an amine, an amide from the group consisting of N, dimethylformamide or N,N-dimethylacetamide, an alkamine with 4 to 8 hydramines, a pyrrolidinone, and combinations thereof. In one of more embodiments of the electron donor, the phosphate compound may be phosphoric acid alkyl ester with 1 to 4 carbon atoms.

In one or more embodiments of the heterogeneous catalyst, the molar ratio of the electron donor to Lewis acid may be in a range of about 1:10 to 2:1.

Polymerization of Isobutylene

In one or more embodiments, isobutylene may be polymerized to highly-reactive polyisobutylene in the presence of the disclosed heterogeneous catalyst. As discussed above, the polymerization may be a cationic polymerization.

Isobutylene monomers in accordance with one or more embodiments of the present disclosure may be selected from pure isobutylene, a Raffinate-1, or a mixture of isobutylene with other hydrocarbons. For example, in one or more embodiments, isobutylene may be sourced from C₄ and C₅ cuts obtained by catalytic dehydrogenation of isobutane from steam crackers and from fluid catalytic cracking, and thus may contain other C₄ and C₅ species along with the isobutylene.

In one or more embodiments, the heterogeneous catalyst, solvent, and water may be added to a reaction vessel under in an inert environment. The solvent in accordance with one or more embodiments of the present disclosure may be an organic solvent such as an aliphatic, or cycloaliphatic, or aromatic hydrocarbons, or halogenated aliphatic hydrocarbons or a mixture thereof. The solvent may also be an inert diluent used to reduce the increase in the viscosity of the reaction solution, which generally occurs during the polymerization reaction to such an extent that the removal of the heat of reaction which evolves can be ensured. Suitable diluents are those solvents or solvent mixtures which are inert toward the reagents used. Examples of suitable solvents are aliphatic hydrocarbon, cycloaliphatic hydrocarbon, aromatic hydrocarbon, halogenated aliphatic hydrocarbon, halogenated aromatic hydrocarbons, and alkyl aromatic halogenated in the alkyl side chains. In one or more embodiments, the aliphatic hydrocarbon may be ethane, propane, butane, or pentane, or hexane, or heptane, or a mixture thereof. The aromatic hydrocarbon may be benzene, toluene, or xylenes. The halogenated aliphatic hydrocarbons may be dichloromethane or dichloroethane or a mixture thereof.

In one or more embodiments, the polyisobutylene is obtained through polymerization of isobutylene in a range of temperatures from −100° C. to about 50° C. The polymerization may be performed at a temperature in between −20° C. and 50° C. to reduce the complexity and energy consumptions of the experimental procedure. When the polymerization is performed at or above the boiling temperature of the monomer or monomer mixture to be polymerized, it may be performed in pressure vessels, for example in autoclaves or in pressure reactors. In one or more embodiments, the polymerization may be carried out in a fixed-bed reactor, a fluidized bed reactor, a Micro-channel reactor, or a continuous stirred-tank reactor. In one or more embodiments, the reactor is pressurized at pressures in between ambient pressure and 50 bar.

In one or more embodiments of the present disclosure, the reaction time between the isobutylene monomer, the catalyst and the co-catalyst may be in the range of 1 to 100 minutes.

The reaction in accordance with one or more embodiments of the present disclosure may be quenched by the addition of caustic water, water, or an alcohol, such as ethanol and i-propanol, to the reaction mixture. The heterogeneous catalyst may be separated from the reaction medium, and solvent and dissolved unreacted isobutylene may be removed by evaporation.

Polymerizing isobutylene in the presence of the claimed heterogenous catalyst composition may allow for the formation of highly reactive polyisobutylene, i.e., a polyisobutylene having a terminal vinylidene content of at least 50 mol %. The vinylidene content of the polyisobutylene product may be measured by NMR by dissolving the polyisobutylene product in a suitable NMR solvent such as deuterated chloroform or hexane. The vinylidene content in accordance with one or more embodiments of the present disclosure may be in an amount ranging between around 50% to about 90%. The vinylidene content may be in an amount having a lower limit of any of 50 wt. %, 55 wt %, 60 wt %, 65 wt % or 70 wt %, to an upper limit of any of 85 wt %, 86 wt %, 87 wt %, 88 wt %, 89 wt % or 90 wt %.

In one or more embodiments, the heterogeneous catalyst may have a catalytic activity calculated from the amount of isobutylene consumed, amount of Lewis acid, and reaction time using the equation below:

Catalytic activity=moles of isobutylene consumed/(moles of Lewis acid*reaction time)

where catalytic activity is in mol_{IB}mol_{Al}⁻¹s⁻¹, moles of isobutylene consumed and moles of Al in moles, and reaction time in seconds.

In one or more embodiments, the catalytic activity may range from about 0.001 to 1 mol_{IB}mol_{Al}⁻¹s⁻¹. For example, the catalytic activity may have a lower limit of any of 0.001, 0.005, 0.01, 0.05, 0.1, 0.15, or 0.2 to an upper limit of any of 0.3, 0.4, 0.5, 0.75, or 1, where any lower limit can be used with any upper limit.

### Examples

The following examples are merely illustrative and should not be interpreted as limiting the scope of the present disclosure.

Materials

Aluminum chloride (99.99%) and ethylaluminum chloride (>97%) were purchased from Sigma Aldrich. Dipropyl ether (nPr₂O, >99%), diisopropyl ether (iPr₂O, 99%), or dibutyl ether (nBu₂O, >99%) were purchased from Sigma Aldrich. Silica-1 was purchased from Fuji Silysia Chemical. Silica-2 and 3-Aminopropyl-functionalized silica gel (with ˜1 mmol/g NH₂ loading and 40-63 μm) were purchased from Sigma Aldrich. Hexane (anhydrous >99%), and ethanol (>99.5) were purchased from Sigma Aldrich. Isobutylene liquified gas cylinder were purchased from Air Gas (>99.5%, with less than 3 ppm water). The zirconia support used in examples 7a, 10a, 15a, and 18a, is zirconium hydroxide from Luxfer Mel Technologies, XZ01247101.

Methods

The vinylidene content of polyisobutylene product was measured by proton NMR spectroscopy using a PicoSpin 80™ NMR from ThermoFisher Scientific. Proton NMR vinylidene content was determined according to the methodology proposed by J. D. Burrington et al. “Cationic Polymerization Using Heteropolyacid Salt Catalysts” that provides general methods of polymer analysis by NMR spectroscopy [Topics in Catalysis 23, 175-181 (2003)] and is incorporated herein in its entirety.

The activity of the catalyst was determined using the formula below:

Catalytic activity=moles of isobutylene consumed/(moles of Lewis acid*reaction time)

where catalytic activity is in mol_{IB}mol_{Al}⁻¹s⁻¹, moles of isobutylene consumed and moles of Al in moles, and reaction time in seconds.

Preparation of the Heterogeneous Catalyst Composition

In the following example, heterogeneous catalyst compositions were prepared in a 1 mL vial equipped with a magnetic stirring bar by mixing a Lewis acid loaded onto a metal oxide support, an initiator, and optionally an electron donor in a solvent in a glove box. In all of the heterogeneous catalyst composition, the solvent and initiator were hexane and water respectively. Heterogeneous catalyst compositions prepared are shown in Table 1. Samples 1-4 and 11-12 are comparative examples and samples 5-10 and 13-18 are inventive samples.

TABLE 1

| Sample | Lewis acid | Electron donor | Support |
|---|---|---|---|
| 1 (CE) | AlCl₃ | None | None |
| 2 (CE) | AlCl₃ | iPr₂O | None |
| 3 (CE) | AlCl₃ | nPr₂O | None |
| 4 (CE) | AlCl₃ | nBu₂O | None |
| 5 | AlCl₃ | None | Silica-1 |
| 6 | AlCl₃ | None | Silica-2 |
| 7 | AlCl₃ | None | NH₂-Silica |
| 7a | AlCl₃ | None | Zirconia |
| 8 | AlCl₃ | iPr₂O | Silica-1 |
| 9 | AlCl₃ | iPr₂O | Silica-2 |
| 10 | AlCl₃ | iPr₂O | NH₂-Silica |
| 10a | AlCl₃ | iPr₂O | Zirconia |
| 11 (CE) | EtAlCl₂ | None | None |
| 12 (CE) | EtAlCl₂ | iPr₂O | None |
| 13 | EtAlCl₂ | None | Silica-1 |
| 14 | EtAlCl₂ | None | Silica-2 |
| 15 | EtAlCl₂ | None | NH₂-Silica |
| 15a | EtAlCl₂ | None | Zirconia |
| 16 | EtAlCl₂ | iPr₂O | Silica-1 |
| 17 | EtAlCl₂ | iPr₂O | Silica-2 |
| 18 | EtAlCl₂ | iPr₂O | NH₂-Silica |
| 18a | EtAlCl₂ | iPr₂O | Zirconia |

The ratio of water (initiator) to aluminum (Lewis acid) was 1:1. For 0.04 mmol of aluminum, 0.02 g of dried silica was added. The vial was placed in a customized reaction block, sealed inside a Parr reactor, and transferred out of the glove box.

Polymerization of Isobutylene to Highly-Reactive Polyisobutylene

Pure isobutylene gas was added into the reactor under vigorous stirring at 600 rpm and the total pressure was maintained at 10 psig for 30 mins at 30° C. (303 K). The isobutylene input was closed after 30 minutes and the reactor depressurized. To quench the polymerization reaction, 10 μL of ethanol was added to the vials. A 0.2 μm PTFE filter was used to remove the heterogeneous catalyst from the reaction medium. The unreacted isobutylene and solvent were removed by evaporation at 80° C. (353 K) overnight. The amount of polyisobutylene formed was measured using a precise balance.

Table 2 below shows the catalytic activity and percent vinylidene of the different heterogeneous catalyst compositions.

TABLE 2

| | Activity | Vinylidene |
|---|---|---|
| Sample | (mol_{IB} mol_{A1}⁻¹ s⁻¹) | % |
| 1 (CE) | 0.12 | 12 |
| 2 (CE) | 0.041 | 37 |
| 3 (CE) | 0.034 | 36 |
| 4 (CE) | 0.075 | 13 |
| 5 | 0.092 | 31 |
| 6 | 0.031 | 17 |
| 7 | 0.072 | 15 |
| 7a | 0.056 | 21 |
| 8 | 0.068 | 72 |
| 9 | 0.037 | 67 |
| 10 | 0.047 | 86 |
| 10a | 0.048 | 47 |
| 11 (CE) | 0.17 | 13 |
| 12 (CE) | 0.033 | 75 |
| 13 | 0.048 | 51 |
| 14 | 0.052 | 53 |
| 15 | 0.075 | 38 |
| 15a | 0.058 | 35 |
| 16 | 0.055 | 85 |
| 17 | 0.044 | 74 |
| 18 | 0.028 | 84 |
| 18a | 0.039 | 82 |

Without electron donor or support, AlCl₃ or EtAlCl₂ catalysts produce polyisobutylene products with low vinylidene content (10 mol %-15 mol %). As shown by the comparative examples in Table 2, catalyst composition with AlCl₃ (comparative example 1) or EtAlCl₂ (comparative example 11) only results in the highest catalyst activity (0.12 and 0.17 mol_{IB} mol_{Al}⁻s⁻¹) and lowest content of vinylidene per polyisobutylene chain of 12 mol % and 13 mol % respectively. The catalytic activity and generation of moles of vinylidene of AlCl₃ and EtAlCl₂ used alone was found to be comparable.

Samples 5-7 and 13-15 use catalyst compositions with a Lewis acid and support only. By immobilizing AlCl₃ to silica, functionalized silica, or Zirconia, the resulting polyisobutylene already exhibits a slightly higher vinylidene content of less than 35% (Samples 5-7) compared to Lewis acid only catalyst compositions. By immobilizing EtAlCl₂ to silica, functionalized silica or zirconia, the resulting polyisobutylene already exhibits an increase in vinylidene content between 30 mol % and 55 mol % (Samples 13-15). Catalyst compositions with EtAlCl₂ as the Lewis acid exhibit higher percent of vinylidene per polybutylene chain (51 mol %, 53 mol %, and 38 mol %) compared to samples with AlCl₃ (31 mol %, 17 mol %, and 15 mol %) as the Lewis acid.

Comparative examples 2-4 and 12 use catalyst compositions with a Lewis acid and an electron donor. Addition of alkyl ether as electron donor to AlCl₃ increased the vinylidene content of polyisobutylene to between 30-40 mol % (comparative examples 2-4). Addition of alkyl ether as electron donor to EtAlCl₂ led to a polyisobutylene product with satisfactory vinylidene content of greater than 70 mol % (comparative example 12). Interestingly, comparative example 12 has a higher percent of vinylidene per polybutylene chain (75 mol %) compared to comparative example 2 (37 mol %), even though both comparative example 2 and 12 use diisopropyl ether as the electron donor. Comparative example 12 uses EtAlCl₂ as the Lewis acid and comparative example 2 uses AlCl₃ as the Lewis acid, indicating that EtAlCl₂ and diisopropyl ether may have a synergistic effect in increasing the percent of vinylidene per polybutylene chain.

Adding electron donor to the EtAlCl₂ or AlCl₃ supported by silica, functionalized silica, or Zirconia resulted in an increase in vinylidene content. In particular, silica-supported EtAlCl₂ (Sample 16), functionalized silica-supported EtAlCl₂ (Sample 18), Zirconia-supported EtAlCl₂ (Sample 18A) and functionalized silica-supported AlCl₃ (Sample 10), demonstrated the highest vinylidene content of 85 mol %, 84 mol %, 82% and 86 mol % and catalytic activity of 0.055, 0.028, 0.039 and 0.047 mol_{IB} mol_{Al}⁻s⁻¹ respectively.

The disclosed catalyst not only produced highly-reactive polyisobutylene with ˜85 mol % vinylidene content, but also is in solid form so that the process can be intensified compared to incumbent process.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A heterogeneous catalyst composition for preparing a highly-reactive polyisobutylene comprising:
a Lewis acid;
a support;
an initiator; and
optionally, an electron donor.

2. The heterogeneous catalyst composition of claim 1, wherein the Lewis acid is a metal halide compound or an alkyl halide compound.

3. The heterogeneous catalyst composition of claim 2, wherein the metal halide compound comprises a formula MⁿX⁻¹ₙ, wherein M is a metal, X is a halide, and n is number of valence electrons, wherein M is Al, B, Fe or Ti, X is F, Cl, or Br, and n is 3 or 4.

4. The heterogeneous catalyst composition of claim 2, wherein the alkyl metal halide comprises a formula R⁺¹ₘMⁿ⁺X⁻¹ₙ₋ₘ,
wherein R is an alkyl group, M is a metal, X is a halide, m is number of the alkyl groups, m is in a range of 1 to n−1, and n is number of valence electrons,
wherein M is Al or Ti;
wherein X is F, Cl, or Br;
wherein n is 3 or 4; and
wherein the alkyl group R comprises a formula CᵢH₂ᵢ₊₁, wherein i ranges from 2 to 10.

5. The heterogeneous catalyst composition of claim 1, wherein the support is a metal oxide.

6. The heterogeneous catalyst composition of claim 5, wherein the metal oxide is from the group consisting of a silica, silica-alumina, clay, crystalline porous silicate, silicoaluminophosphate, titania, vanadia, or a rare earth oxide.

7. The heterogeneous catalyst composition of claim 1, wherein the support is a metal oxide with a functional group, wherein the functional group is selected from the group consisting of a hydroxyl, a carboxylic acid, an amino or a thiol group.

8. The heterogeneous catalyst composition of claim 1, wherein the initiator is a water or an alcohol, an organic acid, an inorganic acid or an alkyl chloride,
wherein the alcohol is selected from the group consisting of ethanol, n-propanol, i-propanol, n-butanol, 2-butanol, or t-butanol;
wherein the organic acid is selected from the group consisting of acetic acid, propanoic acid, or butanoic acid;
wherein the inorganic acid is selected from the group consisting of HCl, H₂SO₄, or H₃PO₄;
wherein the alkyl chloride is selected from the group consisting of C₂H₅Cl, n-C₃H₇Cl, i-C₃H₇Cl, n-C₄H₉Cl, 2-C₄H₉Cl, or t-C₄H₉Cl.

9. The heterogeneous catalyst composition of claim 1, wherein a molar ratio of initiator to Lewis acid is in a range of 0.1 to 2.

10. The heterogeneous catalyst composition of claim 1, wherein the electron donor is a compound selected from the group consisting of an alcohol with 1 to 5 carbon atoms, a ketone with 3 to 6 carbon atoms, an ether, an aminated compound, a phosphate compound, a phenol, a pyridine and combinations thereof.

11. The heterogeneous catalyst composition of claim 10, wherein the ether is an alkyl ether.

12. The heterogeneous catalyst composition of claim 10, wherein the aminated compound is an amine, an amide from the group consisting of N, dimethylformamide or N,N-dimethylacetamide, an alkamine with 4 to 8 hydramines, a pyrrolidinone, and combinations thereof.

13. The heterogeneous catalyst composition of claim 10, wherein the phosphate compound is a phosphoric acid alkyl ester with 1 to 4 carbon atoms.

14. A method, comprising:
polymerizing isobutylene to a highly-reactive polyisobutylene in the presence of the heterogeneous catalyst composition of claim 1.

15. The method of claim 14, wherein the isobutylene is a pure isobutylene, a Raffinate-1, or a mixture of isobutylene with other hydrocarbons.

16. The method of claim 14, wherein the highly-reactive polyisobutylene has a vinylidene content greater than 50 mol %.

17. The method of claim 14, wherein the polymerizing occurs at a temperature ranging between −100 and 50° C.
